(19) United States
(12) Patent Application Publication
(10) Pub. No.: US 2015/0264689 A1
(43) Pub. Date: Sep. 17, 2015

(54) METHODS AND APPARATUS FOR MULTIPLEXING PEER-TO-PEER TRAFFIC AND/OR ACCESS POINT TRAFFIC

(71) Applicant: QUALCOMM Incorporated, San Diego, CA (US)

(72) Inventors: Hemanth Sampath, San Diego, CA (US); Simone Merlin, Solana Beach, CA (US); George Cherian, San Diego, CA (US); Srinivas Katar, Gainesville, FL (US); Hao Zhu, Ocala, FL (US)

(21) Appl. No.: 14/658,014

(22) Filed: Mar. 13, 2015

Related U.S. Application Data
(60) Provisional application No. 61/954,366, filed on Mar. 17, 2014.

(51) Int. Cl. H04W 72/04; H04W 4/12; H04W 52/24

(52) U.S. Cl. CPC H04W 72/0453; H04W 52/243; H04W 4/12

(57) ABSTRACT

A method comprises receiving a first message over a first portion of a frequency bandwidth. The first message includes an identifier of a transmitting first wireless device and an intended recipient second wireless device. The method comprises determining whether a second portion of the frequency bandwidth is idle for a duration of time including at least one of a PIFS time and a time required for a backoff timer to expire. The method comprises transmitting a second message over the second portion of the frequency bandwidth by a third wireless device, the second message having a limited transmission time that is not to extend beyond a transmission time of the first message, thereby allowing an availability of the first and second portions for use after an end of the transmission time of the first message. The third wireless device is not an intended recipient of the first message.

### CROSS REFERENCE TO RELATED APPLICATIONS

This application claims priority to Provisional Application No. 61/954,366 entitled “METHODS AND APPARATUS FOR PEER-TO-PEER AND AP TRAFFIC MULTIPLEXING” filed Mar. 17, 2014. The disclosure of Provisional Application No. 61/954,366 is hereby expressly incorporated in its entirety by reference herein.

### FIELD

The present application relates generally to wireless communications, and more specifically to methods and devices for multiplexing peer-to-peer traffic and/or access point traffic.

### BACKGROUND

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

However, multiple wireless networks may exist in the same building, in nearby buildings, and/or in the same outdoor area. The prevalence of multiple wireless networks may cause interference, reduced throughput (e.g., because each wireless network is operating in the same area and/or spectrum), and/or prevent certain devices from communicating. Thus, improved systems, methods, and devices for communicating when wireless networks are densely populated is desired.

### SUMMARY

The systems, methods, and devices described herein each have several aspects, no single one of which is solely responsible for its desirable attributes. Without limiting the scope of this application, some features will now be discussed briefly. After considering this discussion, and particularly after reading the section entitled “Detailed Description” one will understand how the features of one or more implementations herein provide advantages that include improved communications between access points and stations in a wireless network.

One aspect of this disclosure provides a method for wireless communication. The method includes receiving a first message over a first portion of a frequency bandwidth, wherein the first message includes an identifier of a transmitting first wireless device and an intended recipient second wireless device. The method comprises determining whether a second portion of the bandwidth is idle for a duration of time including at least one of a point coordination function interframe space (PIFS) time and a time required for a backoff timer to expire. The method comprises transmitting a second message over the second portion of the frequency bandwidth by a third wireless device. The second message has a limited transmission time that is not to extend beyond a transmission time of the first message, thereby allowing an availability of the first and second portions of the frequency bandwidth for use at least after an end of the transmission time of the first message. The third wireless device is not an intended recipient of the first message.

Another aspect of this disclosure provides an apparatus for wireless communication. The apparatus includes a receiver configured to receive a first message over a first portion of a frequency bandwidth, wherein the first message includes an identifier of a transmitting first wireless device and an intended recipient second wireless device. The apparatus further includes a processor configured to determine whether a second portion of the frequency bandwidth is idle for a duration of time including at least one of a point coordination function interframe space (PIFS) time and a time required for a backoff timer to expire. The apparatus further includes a a transmitter configured to transmit a second message over the second portion of the frequency bandwidth, the second message having a limited transmission time that is not to extend beyond a transmission time of the first message, thereby allowing an availability of the first and second portions of the frequency bandwidth for use at least after an end of the transmission time for the first message, wherein the apparatus is not an intended recipient of the first message.

Another aspect of this disclosure provides a non-transitory, computer-readable medium comprising code that, when executed, causes a processor of an apparatus for wireless communication to receive a first message over a first portion of a frequency bandwidth, wherein the first message includes an identifier of a transmitting first wireless device and an intended recipient second wireless device. The code, when executed, causes the processor to determine whether a second portion of the frequency bandwidth is idle for a duration of time including at least one of a point coordination function interframe space (PIFS) time and a time required for a backoff timer to expire. The code, when executed, causes the processor to transmit a second message over the second portion of the frequency bandwidth, the second message having a limited transmission time that is not to extend beyond a transmission time of the first message, wherein the apparatus is not the intended recipient of the first message.

Another aspect of this disclosure provides an apparatus for wireless communication. The apparatus includes means for receiving a first message over a first portion of a frequency bandwidth, wherein the first message includes an identifier of a transmitting first wireless device and an intended recipient second wireless device. The apparatus further comprises means for determining whether a second portion of the frequency bandwidth is idle for a duration of time including at least one of a point coordination function interframe space (PIFS) time and a time required for a backoff timer to expire. The apparatus further comprises means for transmitting a second message over the second portion of the frequency bandwidth, the second message having a limited transmission time that is not to extend beyond a transmission time of the first message. wherein the apparatus is not an intended recipient of the first message.

### BRIEF DESCRIPTION OF THE DRAWINGS

FIG. 1 shows a wireless communication system in which aspects of the present disclosure may be employed.

FIG. 2A shows a wireless communication system in which multiple wireless communication networks are present.

FIG. 2B shows another wireless communication system in which multiple wireless communication networks are present.

FIG. 3 shows frequency multiplexing techniques that may be employed within the wireless communication systems of FIGS. 1 and 2B.

FIG. 4 shows a functional block diagram of a wireless device that may be employed within the wireless communication systems of FIGS. 1, 2B, 3, and 5A-5C.

FIG. 5A shows a wireless communication system in which aspects of the present disclosure may be employed.

FIG. 5B shows a timing diagram in which aspects of the present disclosure may be employed.

FIG. 5C shows another timing diagram in which aspects of the present disclosure may be employed.

FIG. 6 is a flowchart of a method for wireless communication.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of, or combined with, any other aspect. For example, an apparatus may be implemented or a method may be practiced using any number of the aspects set forth herein. In addition, the scope of this application is intended to cover such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, certain devices implementing a high-efficiency 802.11 protocol using the techniques disclosed herein may include allowing for increased peer-to-peer (P2P) services (e.g., Miracast, WiFi Direct Services, Social WiFi, etc.) in the same area, supporting increased per-user minimum throughput requirements, supporting more users, providing improved outdoor coverage and robustness, and/or consuming less power than devices implementing other wireless protocols.

In some implementations, a WLAN includes various devices which are the components that access the wireless network. For example, there may be two types of devices: access points (“APs”) and stations (“STAs”). In general, an AP may serve as a hub or base station for the WLAN. An AP may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

In general, an STA serves as a user of the WLAN. An STA may also comprise, be implemented as, or known as an access terminal (“AT”), a subscriber station, a subscriber unit, a mobile station, a remote station, a remote terminal, a user terminal, a user agent, a user device, user equipment, or some other terminology. An STA may be a laptop computer, a personal digital assistant (PDA), a mobile phone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium. In some implementations, an STA may also be used as an AP.

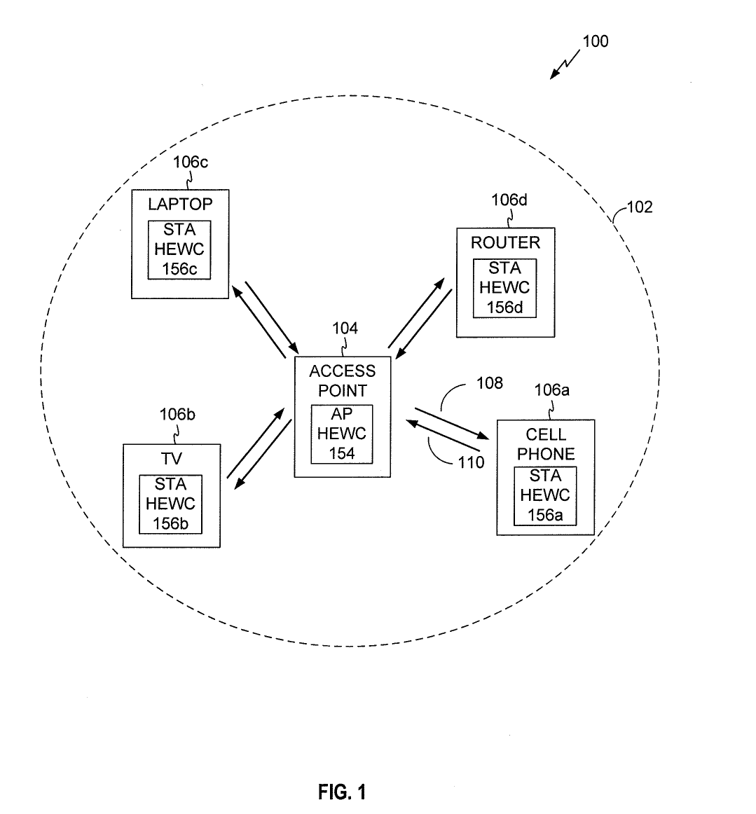

FIG. 1 shows a wireless communication system 100 in which aspects of the present disclosure may be employed. The wireless communication system 100 may operate pursuant to a wireless standard, for example a high-efficiency 802.11 standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. In such implementations, the wireless communication system 100 may be referred to as an OFDM/OFDMA system. Alternatively, signals may be sent and received between the AP 104 and the STAs 106 in accordance with code division multiple access (CDMA) techniques. In such implementations, the wireless communication system 100 may be referred to as a CDMA system. A communication link that facilitates transmission from the AP 104 to one or more of the STAs 106 may be referred to as a downlink (DL), forward link or forward channel 108, and a communication link that facilitates transmission from one or more of the STAs 106 to the AP 104 may be referred to as an uplink (UL), a reverse link, or a reverse channel 110.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP, but rather may function as a peer-to-peer network between the STAs 106. Accordingly, the functions of the AP 104 described herein may alternatively be performed by one or more of the STAs 106.

In some aspects, a STA 106 may be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

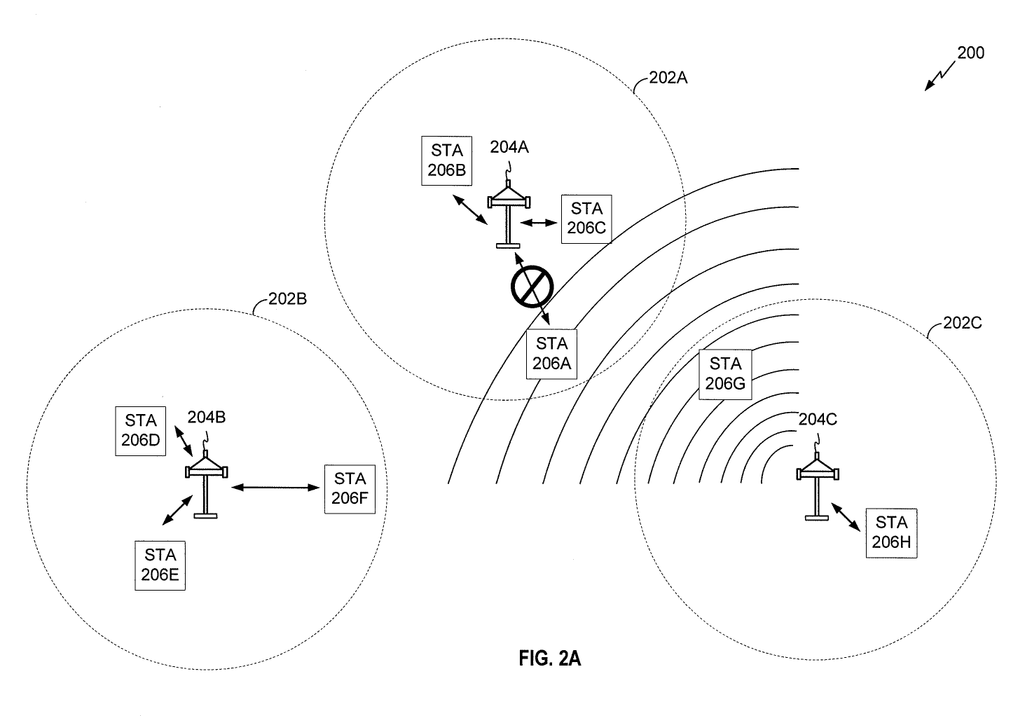

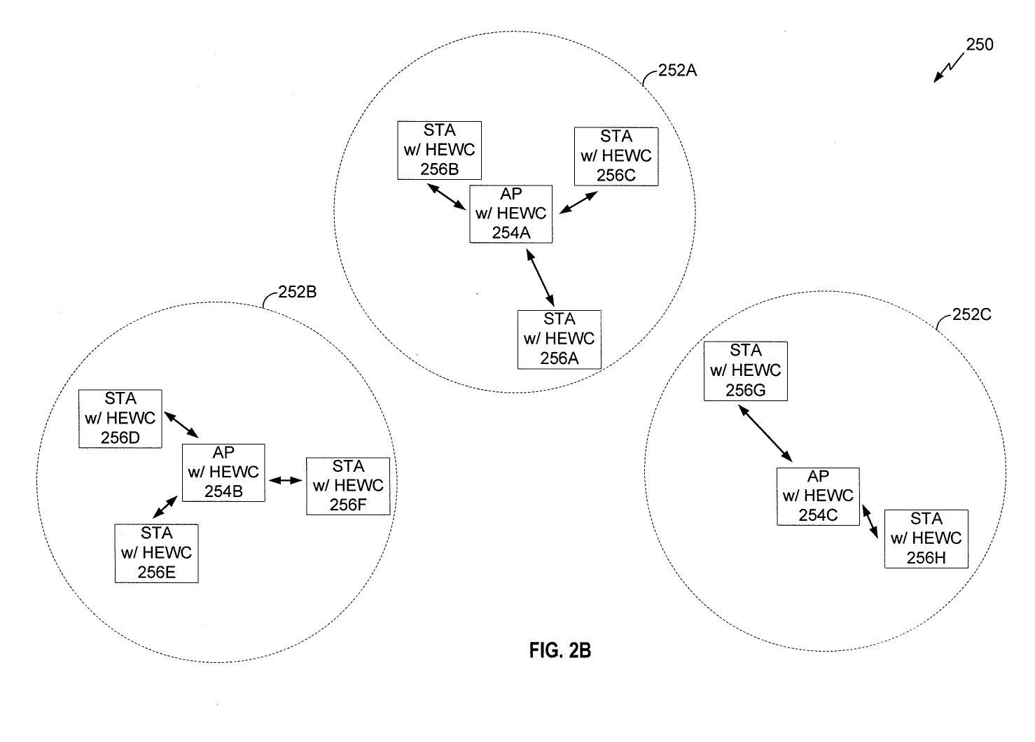

In some implementations, the AP 104 includes an AP high-efficiency wireless component (HEWC) 154. The AP HEWC 154 may perform some or all of the operations described herein to enable communications between the AP 104 and the STAs 106 using the high-efficiency 802.11 protocol. The functionality of the AP HEWC 154 is described in greater detail below with respect to FIGS. 2B, 3, 4, 5A-C, and 6.

Alternatively or in addition, the STAs 106 may include a STA HEWC 156. The STA HEWC 156 may perform some or all of the operations described herein to enable communications between the STAs 106 and the AP 104 using the high-efficiency 802.11 protocol. The functionality of the STA HEWC 156 is described in greater detail below with respect to FIGS. 2B, 3, 4, 5A-C, and 6.

In some circumstances, a BSA may be located near other BSAs, as may be shown in more detail in connection with FIG. 2A, which shows a wireless communication system 200 in which multiple wireless communication networks are present. As illustrated in FIG. 2A, the BSAs 202A, 202B, and 202C may be physically located near each other. Despite the close proximity of the BSAs 202A-202C, the APs 204A-204C and/or STAs 206A-206H may each communicate using the same spectrum (e.g., utilizing the same collection of frequency bands or channels). Thus, if a device in the BSA 202C (e.g., the AP 204C) is transmitting data, devices outside the BSA 202C (e.g., APs 204A-204B or STAs 206A-206F) may sense the communication on the medium.

Generally, wireless networks that use a regular 802.11 protocol (e.g., 802.11a, 802.11b, 802.11g, 802.11n, etc.) operate under a carrier sense multiple access (CSMA) mechanism for medium access. According to CSMA, devices sense the medium and only transmit when the medium is sensed to be idle. Thus, if the APs 204A-204C and/or STAs 206A-206H are operating according to the CSMA mechanism and a device in the BSA 202C (e.g., the AP 204C) is transmitting data, then the APs 204A-204B and/or STAs 206A-206F outside of the BSA 202C may not transmit over the medium even though they are part of a different BSA.

FIG. 2A illustrates such a situation. The AP 204C is shown transmitting over the medium. The transmission is sensed by the STA 206G, which is in the same BSA 202C as the AP 204C, and by STA 206A, which is in a different BSA than the AP 204C. While the transmission may be addressed to the STA 206G and/or only STAs in the BSA 202C, the STA 206A nonetheless may not be able to transmit or receive communications (e.g., to or from the AP 204A) until the AP 204C (and any other device) is no longer transmitting on the medium. Although not shown, the same may apply to the STAs 206D-206F in the BSA 202B and/or STAs 206B-206C in the BSA 202A (e.g., if the transmission by the AP 204C is stronger such that the other STAs can sense the transmission on the medium).

The use of the CSMA mechanism can create inefficiencies since some APs or STAs outside of a BSA could conceivably transmit data without interfering with a transmission made by an AP or STA in that BSA. As the number of active wireless devices continues to grow, the inefficiencies may begin to significantly affect network latency and throughput. For example, in apartment buildings each apartment unit may include an access point and associated stations. In some cases, each apartment unit may include multiple access points, since a resident may own a wireless router, a video game console and/or television with wireless media center capabilities, a cell phone that can act like a personal hot-spot, and/or the like.

Such inefficiencies are not confined to residential areas. For example, multiple access points may be located in airports, subway stations, and/or other densely-populated public spaces. Currently, WiFi access may be offered in these public spaces for a fee. If the inefficiencies created by the CSMA mechanism are not corrected, operators of the wireless networks may lose customers as fees and low quality of service begin to outweigh the benefits. Thus, correcting the inefficiencies of the CSMA mechanism may be vital to avoid latency and throughput issues and overall user dissatisfaction.

Another functionality that has both positive and negative effects on the inefficiencies of the CSMA mechanism are peer-to-peer (P2P) applications, where a STA communicates directly with another STA in the BSS. P2P applications are expected to become more ubiquitous in the coming years. For example, cell phones increasingly have the ability to communicate directly with other cell phones (e.g., to share photos, music, video, etc.). By communicating directly with each other, the STAs can avoid some potential latency issues by removing the requirement that all STA communications must first pass through an AP.

There are two main protocols that can be used for P2P communications. The first, tunneled direct link setup (TDLS), which is defined by IEEE, allows for peer-to-peer communications between STAs that are associated with the same AP. The second, WiFi Direct, which is a Wi-Fi Alliance protocol, allows a STA to behave similarly to an AP and connect to any other STAs that are similarly equipped in the area.

Currently, transmissions from different BSSs are already allowed to occur simultaneously over different portions of a same operating BW, as long as the primary channels of the two BSSs are set to different frequencies. Similarly, P2P transmissions (including TDLS) may occur in disjoint channels. However, the current standards may not provide optimal reuse of frequency bandwidth. Moreover, the current standards assume that wireless devices from different BSSs do not need to communicate with each other. In such asynchronous operation modes, different BSSs are “hidden” from one another.

Additionally, neither P2P protocol has the capability to coordinate an explicit coexistence between peer-to-peer transmissions (e.g., transmissions between STAs in a BSS) and co-located AP BSS transmissions (e.g., transmissions between an AP and a STA in the BSS, referred to as AP traffic communications or transmissions). The lack of a protocol explicitly defining such coordination is problematic. For example, the STAs engaging in peer-to-peer communications may interfere with AP-to-STA communications, and vice-versa. Furthermore, the network may suffer from increased latency and reduced throughput when STAs are required to wait for an AP to finish communicating with another STA or when an AP is required to wait for P2P STAs to finish communicating.

Accordingly, an explicit coordination mechanism is described herein for use with the high-efficiency 802.11 protocol. The coordination mechanism may be based on a multiplexing of medium access in frequency. Such implementations allow for concurrent peer-to-peer, STA-to-AP, and/or AP-to-STA traffic communications. For example, a communication medium may have a certain frequency bandwidth (e.g., 80 MHz). Normally, a portion or the entire frequency bandwidth is used by the AP during communications to and from the STAs. However, as described herein, a portion of the frequency bandwidth of the communication medium (e.g., 20 MHz) may be reserved for AP traffic communications, whereas another portion of the frequency bandwidth of the communication medium (e.g., 20 MHz) may be reserved for peer-to-peer communications. In other words, in some implementations, the communication medium may be divided into segments or channels, and one or more of the segments or channels may be reserved for AP traffic communications or peer-to-peer communications.

Additionally, in some implementations of a wide band BSS (e.g., 80 MHz), a portion of the frequency bandwidth may be unused due to STAs transmitting at a limited frequency bandwidth because of link conditions (e.g., signal-to-noise ratio (SNR)) or because of the STAs capabilities (e.g., a 20 MHz only STA operating in a 80 MHz BSS). Assuming a STA or AP transmits on a limited frequency bandwidth, the portion of unused frequency bandwidth segments or channels may be made available for additional concurrent transmissions.

The portions, segments or channels could each have the same frequency bandwidth or could be of different frequency bandwidths. For example, one portion, channel or segment could have a frequency bandwidth of 20 MHz and another could have a frequency bandwidth of 40 MHz. Furthermore, the portions, channels or segments may or may not be contiguous (e.g., the portions, channels or segments cover consecutive frequency ranges). If two portions, channels or segments each have a frequency bandwidth of 20 MHz, the two portions, channels or segments may be contiguous if they cover a continuous 40 MHz range, such as from 1000 MHz to 1040 MHz.

Accordingly, the high-efficiency 802.11 protocol may allow for devices to operate under a modified mechanism that minimizes CSMA inefficiencies and increases network throughput, as is described below with respect to FIGS. 2B, 3, 4, 5A-5C and 6.

FIG. 2B shows a wireless communication system 250 in which multiple wireless communication networks are present. Unlike the wireless communication system 200 of FIG. 2A, the wireless communication system 250 of FIG. 2B may operate pursuant to the high-efficiency 802.11 standard discussed herein. The wireless communication system 250 may include an AP 254A, an AP 254B, and an AP 254C. The AP 254A may be associated with and communicate with STAs 256A-256C, the AP 254B may be associated with and communicate with STAs 256D-256F, and the AP 254C may be associated with and communicate with STAs 256G-256H.

The AP 254A may act as a base station and provide wireless communication coverage in a BSA 252A. The AP 254B may act as a base station and provide wireless communication coverage in a BSA 252B. The AP 254C may act as a base station and provide wireless communication coverage in a BSA 252C. It should be noted that each BSA 252A, 252B, and/or 252C may not have an AP 254A, 254B, or 254C, but rather may allow for peer-to-peer communications between one or more of the STAs 256A-H. Accordingly, the functions of the AP 254A-C described herein may alternatively be performed by one or more of the STAs 256A-H.

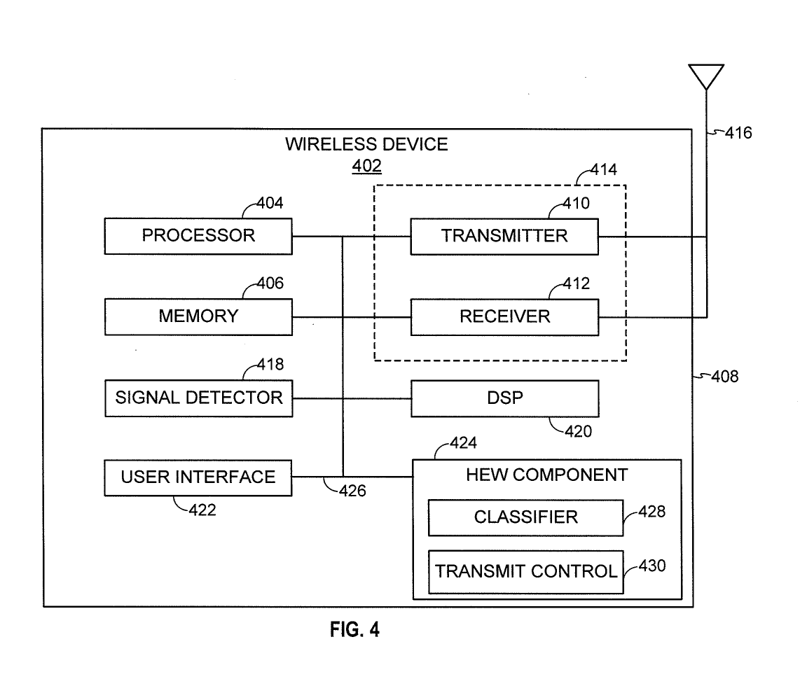

In some implementations, the APs 254A-C and/or STAs 256A-256H include a high-efficiency wireless component as previously described in connection with FIG. 1. The high-efficiency wireless components may enable the APs 254A-256C and/or STAs 256A-256H to use a modified mechanism that minimizes the previously described inefficiencies of the CSMA mechanism by enabling concurrent communications over the medium in situations in which interference would not occur but where the CSMA mechanism would normally disallow concurrent communication. This mechanism is not limited to communications between peer STAs but may also be contemplated for communications between an AP and any one or more STAs. The high-efficiency wireless component will be described in greater detail in connection with FIG. 4.

The BSAs 252A-252C are physically located near each other. When, for example, the AP 254A and the STA 256B are communicating with each other, the communication may be sensed by other devices in the BSAs 252B-252C. However, the communication may only interfere with certain devices, such as the STA 256F and/or the STA 256G. Under CSMA, the AP 254B would not be allowed to communicate with the STA 256E even though such communication would not interfere with the communication between the AP 254A and the STA 256B. Thus, the high-efficiency 802.11 protocol operates under a modified mechanism that differentiates between devices that can communicate concurrently with devices of another BSS and devices that cannot communicate concurrently with devices of another BSS. Such classification of devices may be performed by the high-efficiency wireless component in the APs 254A-254C and/or the STAs 256A-256H.

In some implementations, the determination of whether a device can communicate concurrently with other devices is based on a location of the device. For example, a STA that is located near an edge of the BSA may be in a state or condition such that the STA cannot communicate concurrently with other devices. The STAs 206A, 206F, and 206G may be devices that are in a state or condition in which they cannot communicate concurrently with other devices. Likewise, a STA that is located near the center of the BSA may be in a station or condition such that the STA can communicate with other devices. As illustrated in FIG. 2, the STAs 206B, 206C, 206D, 206E, and 206H may be devices that are in a state or condition in which they can communicate concurrently with other devices. Note that the classification of devices is not permanent. Devices may transition between being in a state or condition such that they can communicate concurrently and being in a state or condition such that they cannot communicate concurrently (e.g., devices may change states or conditions when in motion, when associating with a new AP, when disassociating, etc.).

Furthermore, devices may be configured to behave differently based on whether they are ones that are or are not in a state or condition to communicate concurrently with other devices. For example, devices that are in a state or condition such that they can communicate concurrently may communicate within the same spectrum (e.g., the same frequency band or channel). However, devices that are in a state or condition such that they cannot communicate concurrently may employ certain techniques, such as spatial multiplexing or frequency domain multiplexing, in order to communicate over the medium. The controlling of the behavior of the devices may be performed by the high-efficiency wireless component in the APs 254A-254C and/or the STAs 256A-256H.

In some implementations, devices that are in a state or condition such that they cannot communicate concurrently use spatial multiplexing techniques to communicate over the medium. For example, power and/or other information may be embedded within the preamble of a packet transmitted by another device. A device in a state or condition such that the device cannot communicate concurrently may analyze the preamble when the packet is sensed on the medium and decide whether or not to transmit based on a set of rules.

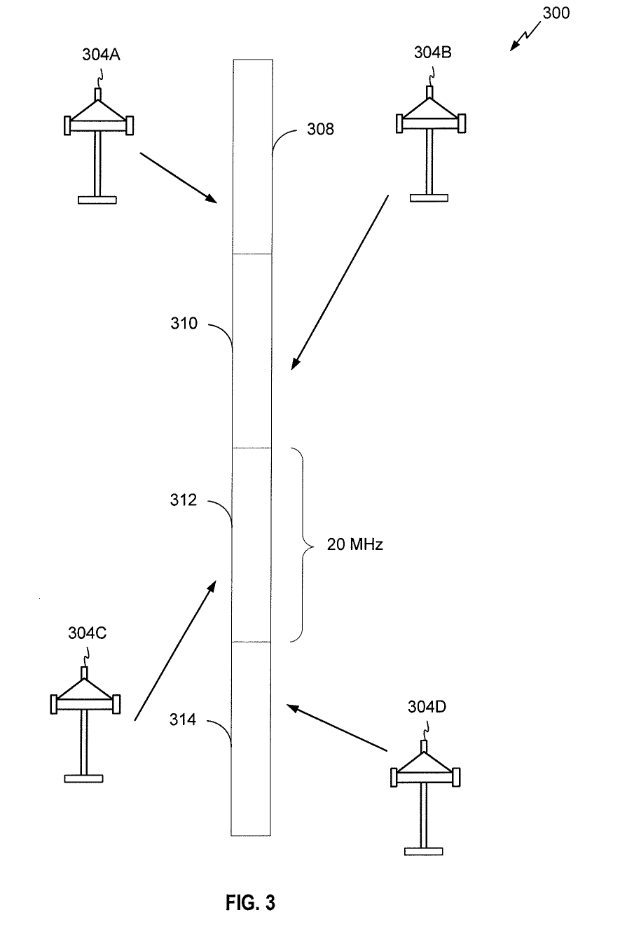

In another implementation, devices that are in a state or condition such that they cannot communicate concurrently may use frequency domain multiplexing techniques to concurrently communicate over the medium. FIG. 3 shows frequency multiplexing techniques that may be employed within the wireless communication systems 100 of FIGS. 1 and 250 of FIG. 2B. As illustrated in FIG. 3, APs 304A, 304B, 304C, and 304D may be present within a wireless communication system 300. Each of the APs 304A, 304B, 304C, and 304D may be associated with a different BSA and include the previously described high-efficiency wireless component.

As an example, the frequency bandwidth of the communication medium may be 80 MHz. Under the regular 802.11 protocol, each of the APs 304A, 304B, 304C, and 304D and the STAs associated with each respective AP attempt to communicate using the entire frequency bandwidth, which can reduce throughput. However, under the high-efficiency 802.11 protocol using frequency domain multiplexing, the frequency bandwidth may be divided into four 20 MHz portions 308, 310, 312, and 314 (e.g., channels). The AP 304A may be associated with portion 308, the AP 304B may be associated with portion 310, the AP 304C may be associated with portion 312, and the AP 304D may be associated with portion 314 (e.g., each of the APs 304A-304D have a different primary channel).

In some implementations, when the APs 304A-304D and the STAs that are in a state or condition such that the STAs can communicate concurrently with other devices (e.g., the STAs near the center of the BSA are communicating with each other), then each AP 304A-304D and each of these STAs may communicate using a portion of or the entire 80 MHz medium. However, when the APs 304A-304D and the STAs that are in a state or condition such that the STAs cannot communicate concurrently with other devices (e.g., the STAs near the edge of the BSA) are communicating with each other, then the AP 304A and its STAs communicate using 20 MHz portion 308, the AP 304B and its STAs communicate using 20 MHz portion 310, the AP 304C and its STAs communicate using 20 MHz portion 312, and the AP 304D and its STAs communicate using 20 MHz portion 314. Thus, a first transmission using a first portion would not interference with a second transmission using a second portion. Thus, APs and/or STAs, even those that are in a state or condition such that they cannot communicate concurrently with other devices that include the high-efficiency wireless component can communicate concurrently with other APs and STAs without interference. Accordingly, the throughput of the wireless communication system 300 may be increased.

FIG. 4 shows a functional block diagram of a wireless device 402 that may be employed within the wireless communication systems 100, 250, and/or 300 of FIGS. 1, 2B, 3, and 5A-5C. The wireless device 402 is an example of a device that may be configured to implement the various methods described herein. For example, the wireless device 402 may comprise the AP 104, one of the STAs 106, one of the APs 254, one of the STAs 256, one of the APs 304, the AP 504 and/or the STAs 506A-506F.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, the state machines, gated logic, discrete hardware components, dedicated hardware finite state machines, or any other suitable entities that can perform calculations or other manipulations of information.

The processing system may also include non-transitory computer-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408 that may include a transmitter 410 and/or a receiver 412 to allow transmission and reception of data between the wireless device 402 and a remote location. The transmitter 410 and receiver 412 may be combined into a transceiver 414. An antenna 416 may be attached to the housing 408 and electrically coupled to the transceiver 414. The receiver 412 may comprise, be a part of, or also known as means for receiving a first message over a first portion of a frequency bandwidth and/or means for receiving a clear to send (CTS) message in response to a request to send (RTS) message over a second portion of a frequency bandwidth. Likewise, the transmitter 410 may comprise, be a part of, or also known as means for transmitting a request to send message over a second portion of the frequency bandwidth when the wireless device 402 is not an intended recipient of a first message. The wireless device 402 may also include (not shown) multiple transmitters, multiple receivers, multiple transceivers, and/or multiple antennas.

The wireless device 402 may also include a signal detector 418 that may be used in an effort to detect and quantify the level of signals received by the transceiver 414. The signal detector 418 may detect such signals as total energy, energy per subcarrier per symbol, power spectral density and other signals. The wireless device 402 may also include a digital signal processor (DSP) 420 for use in processing signals. The DSP 420 may be configured to generate a packet for transmission. In some aspects, the packet may comprise a physical layer data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

The wireless devices 402 may further comprise a high-efficiency wireless component 424 in some aspects. The high-efficiency wireless component 424 may include a classifier unit 428 and a transmit control unit 430. As described herein, the high-efficiency wireless component 424 may enable APs and/or STAs to use a modified mechanism that minimizes the inefficiencies of the CSMA mechanism by enabling concurrent communications over the medium in situations in which interference would not occur.

The modified mechanism may be implemented by the classifier unit 428 and the transmit control unit 430. In some implementations, the classifier unit 428 determines which devices are in a state or condition such that they can communicate concurrently with other devices and which devices are in a state or condition such that they cannot communicate concurrently with other devices. In some implementations, the transmit control unit 430 controls the behavior of devices. For example, the transmit control unit 430 may allow certain devices to transmit concurrently on the same medium (e.g., the same frequency band and/or channel) and allow other devices to transmit using a spatial multiplexing or frequency domain multiplexing technique. The transmit control unit 430 may control the behavior of devices based on the determinations made by the classifier unit 428. Thus, in some implementations, the HEW component 424 with or without one or more other components, such as the signal detector 418 and DSP 420 may comprise, be a part of, or also know as means for determining whether a second portion of the frequency bandwidth is idle for a duration of time, as well as or means for transmitting a second message over the second portion of the frequency bandwidth when the apparatus is not the intended recipient of a first message.

The various components of the wireless device 402 may be coupled together by a bus system 426. The bus system 426 may include a data bus, for example, as well as a power bus, a control signal bus, and a status signal bus in addition to the data bus. Those of skill in the art will appreciate the components of the wireless device 402 may be coupled together or accept or provide inputs to each other using some other mechanism.

Although a number of separate components are illustrated in FIG. 4, those of skill in the art will recognize that one or more of the components may be combined or commonly implemented. For example, the processor 404 may be used to implement not only the functionality described above with respect to the processor 404, but also to implement the functionality described above with respect to the signal detector 418 and/or the DSP 420. Further, each of the components illustrated in FIG. 4 may be implemented using a plurality of separate elements.

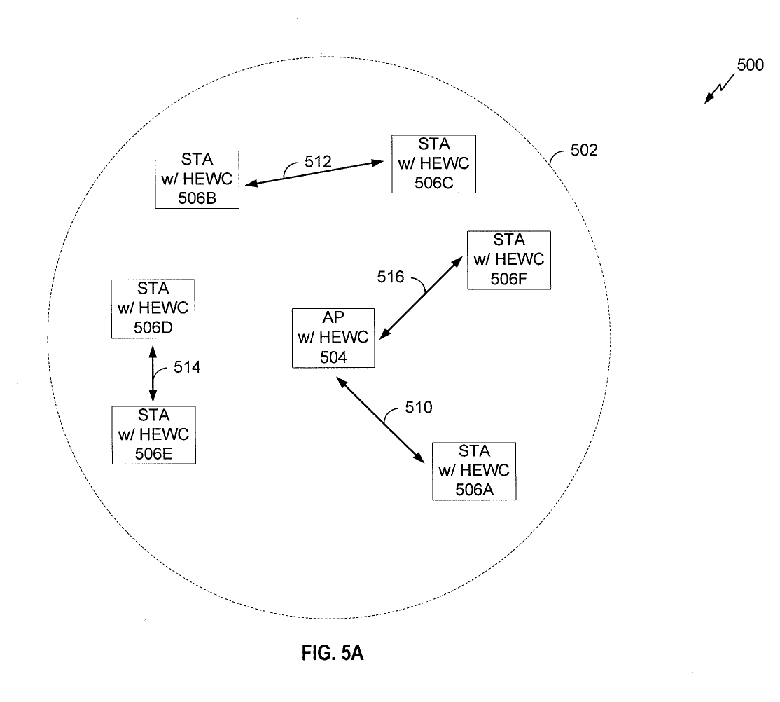

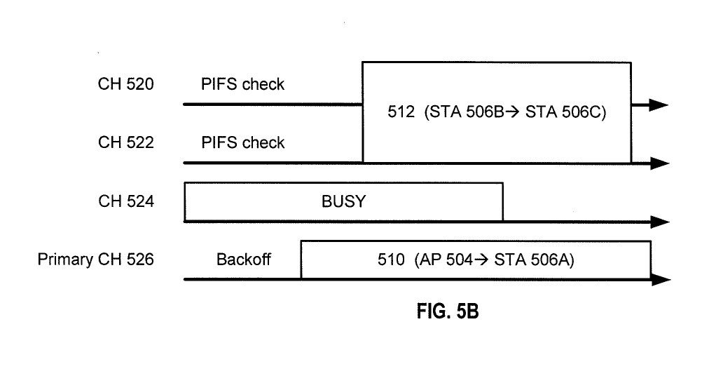

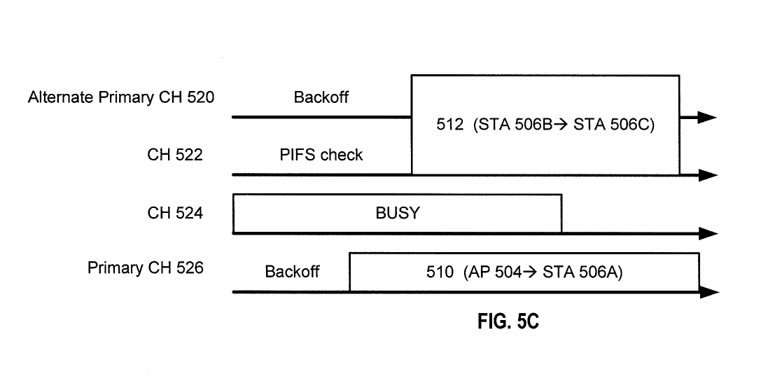

FIG. 5A shows a wireless communication system 500 in which aspects of the present disclosure may be employed. As illustrated in FIG. 5A, the wireless communication system 500 includes a BSA 502. The BSA 502 includes an AP 504 and STAs 506A-506F. In some implementations, the AP 504 and the STAs 506A-506F each include the previously-described high-efficiency wireless component. In other implementations, either the AP 504 or the STAs 506A-506F include the high-efficiency wireless component described herein.

As shown in FIG. 5A, the AP 504 and the STA 506A may communicate with each other via a first message 510. All the STAs 506A-506F may operate according to a CSMA backoff procedure on a primary channel, which is the default channel used for communications in the BSA 502. In some implementations, the first message 510 may be an AP traffic communication. The AP 504 and the STA 506F may communicate via a message 516. In some implementations, the message 516 may also be an AP traffic communication. The STA 506B and the STA 506C may communicate with each other via a second message 512. In some implementations, the second message 512 may be a peer-to-peer communication. The STA 506D and the STA 506E may communicate with each other via a message 514. In some implementations, the message 514 may also be a peer-to-peer communication. Although not shown, the AP 504 and the STAs 506B-506E may have the ability to communicate with each other as well. Likewise, although not shown, the STAs 506A and 506F may also have the ability to communicate with each other.

In some implementations, the AP 504 transmits the first message 510 to the STA 506A over a first portion of the frequency bandwidth (e.g., 20 MHz or one channel of an 80 MHz BSS frequency bandwidth). In some aspects, the AP 504 transmits the first message 510 on a primary channel. Then the STA 506B may transmit at the same time a second message 512 to the STA 506C on a second portion of the frequency bandwidth (e.g., the remaining 60 MHz or the remaining available channels of the 80 MHz BSS frequency bandwidth). In some aspects, the first message 510 and the second message 512 may each comprise a physical layer data unit (PPDU) and may be referred to as PPDU1 and PPDU2, respectively. In some aspects, the first message 510 may comprise a signal (SIG) field that includes an identifier from which other STAs and APs can determine the source (AP 504), the destination (STA 506A), or both of the first message 510. Said another way, the STAs and APs can determine from the identifier whether any of the STAs that would like to transmit or receive on the remaining portion of the frequency bandwidth (e.g., the STAs 506B and 506C) are the intended recipient or transmitter of the first message 510.

If the STAs 506B and 506C are neither the intended recipients or transmitters of the first message 510, then the STA 506B may transmit the second message 512 to the STA 506C on the remaining portion of the frequency bandwidth. In some implementations the transmission time for the second message 512 may be based on the transmission time for the first message 510. For example, in some aspects the transmission time for the second message 512 may be limited to the time used by the transmission time for the first message 510 (e.g., the end of the transmission time for the second message 512 is the same or occurs earlier than, or does not extend beyond, the end of the transmission time for the first message 510). In this aspect, the limited transmission time for the second message 512 ensures that the first portion of the frequency bandwidth (e.g., the primary channel 526) and the second portion of the frequency bandwidth (e.g., the channels 520, 522, 524) are idle at the end of the transmission time of the first message 510. Thus, after the transmissions of the first message 510 and the second message 512, all of the STAs 506 may return to a regular CSMA procedure on a common channel.

In some implementations, the STA 506B may perform a clear channel access (CCA) procedure on the second portion of the frequency bandwidth to determine whether the channel is idle before transmission. In some implementations, after detecting the preamble of the first message 510, the STA 506B may check the CCA on the second portion of the frequency bandwidth for point coordination function interframe space (PIFS) time. Then the STA 506B may transmit on the channels of the second portion that are idle. In another implementation, after detecting the preamble of the first message 510, the STA 506B may perform a backoff procedure on a designated “alternate primary channel” within the second portion of the frequency bandwidth. The backoff procedure may comprise decrementing a backoff timer while one or more channels within the second portion of the frequency bandwidth is idle (e.g., the alternate primary channel). Thus, in some implementations, means for decrementing the backoff timer may comprise a processor within the STA 506B. In some implementations the AP 504 may designate the alternate primary channel. In some implementations, the alternate primary channel may be pre-negotiated. In another implementation, the alternate primary channel may be derived as a function of the frequency bandwidth used by the first message 510. Once the backoff timer expires, the STA 506B may transmit the second message 512 on the alternate primary channel and on other channels within the second portion of the frequency bandwidth, provided the channels were idle for PIFS time before the expiration of the backoff timer. The alternate primary channel and/or the other channels within the second portion of the frequency bandwidth that are idle for PIFS time and are available for transmission of the second message 512 may be considered a “third portion of the frequency bandwidth.” Thus, the third portion of the frequency bandwidth is included in the second portion of the frequency bandwidth.

In some implementations, the receiver STA 506C may detect a potentially incoming packet destined to it, on the second portion of the frequency bandwidth. If the first message 510 is detected both by the STA 506B and the STA 506C, then the STA 506C may determine it is not the intended recipient of the first message 510, hence the STA 506C may tune its packet detection capability to detect a packet incoming on the second portion of the frequency bandwidth, such as in the alternate primary channel. The transmission of the second message 512 may begin with some delay with respect to the first message 510, to allow the STA 506C to decode the preamble of the first message 510, determine if it needs to tune its reception capability to a different channel, and if so tune to the different channel.

The STA 506C may also be able to detect, at the same time, packets incoming on multiple channels, such as both the primary channel and the alternate primary channel, in which case the STA 506C may not need to tune its packet detection capability.

In another implementation, the first message 510 may be detected by STA 506B but not be detected by the STA 506C. In this case, the STA 506B may initiate a transmission intended for the STA 506C on the second portion of the frequency bandwidth, while the STA 506C has no information on whether the transmission may be on the first or second portion of the frequency bandwidth. Similarly, the first message 510 may be detected by the STA 506C but not be detected by the STA 506B. In this case, the STA 506B may initiate a transmission intended for the STA 506C on the first portion of the frequency bandwidth, while the STA 506C may switch to the second portion of the frequency bandwidth. In these cases, the STA 506C may not be able to receive the transmission from the STA 506B, unless it is able to detect at the same time packets incoming on multiple channels. In some implementations, the STA 506B may initiate its transmission with an RTS/CTS to help ensure the STA 506C is in the correct channel.

In some implementations the AP 504A may precede the transmission of the first message 510 with transmission of a first short packet sent on the primary channel, the first packet announcing that the first message 510 will be sent on the first portion of the frequency bandwidth. Upon reception of the first short packet, the STA 506B may send a second short packet indicating that the second message 512 will be transmitted on the second portion of the frequency bandwidth. Upon reception of the second short packet, the STA 506C may tune to the correct channel for reception of the second message 512.

Multiple options for the timing at which the first and second short packets are sent are possible. In some implementations, a time window can be reserved between the first short packet and the first message 510 on the primary channel, and the STA 506B may send the second short packet in this time window based on CSMA. The second short packet indicates the intended receiver, i.e. the STA 506C, and the used channels, so the intended receiver may tune to those channels for reception. In some aspects, there could be multiple STAs contending to send the second short packets. If the first successfully transmitted short packet does not indicate to use all available channels, the other STAs may continue to contend for remaining available channels within the reserved time window. In another implementation, the AP 504 can indicate in the first short packet a selected node, e.g. the STA 506B, which may transmit the second short packet following the first short packet but before the first message 510. This may eliminate the collisions and overhead in the previous implementation. There could also be multiple STAs indicated in the first short packet, which may specify the used channels and the transmission time schedule of the second short packet per STA. In another implementation, the AP 504 and the STA 506A can exchange RTS/CTS on the primary channel before the first message 510, if not all channels are used. After receiving either a RTS or a CTS, other STAs may tune to the unused channels indicated in the RTS or CTS for potential reception.

In some implementations, additional constraints may be performed to limit adjacent channel interference. In some aspects, the STA 506B may not transmit the second message 512 unless the transmission (TX) power of the first message 510, the receive signal strength indicator (RSSI) of the first message 510, or both, satisfy certain thresholds. In some aspects, a threshold of the first message 510 RSSI may be based on an intended transmission power and a reference transmission power. For example, in some implementations, the first message 510 RSSI must be less than a secondary CCA threshold plus the difference between a reference transmission power and an intended transmission power (e.g., the first message 510 RSSI<Secondary_SCA_threshold+(Reference transmission power−Intended transmission power). In another implementation, the AP 504 or the STA 506B may use a request to send/clear to send (RTS/CTS) procedure to limit channel interference. In the RTS/CTS procedure, the AP 504 or the STA 506B may transmit a RTS message to the intended recipient of the PPDU (the STA 506A and the STA 506C, respectively) and the intended recipient transmits a CTS message in response to the RTS. In some aspects, the AP 504 may use the RTS/CTS procedure before transmitting the first message 510. In some aspects, the STA 506B may use the RTS/CTS procedure before transmitting the second message 512.

FIG. 5B shows a timing diagram in which aspects of the present disclosure may be employed. As illustrated in FIG. 5B, the communication medium is divided into four channels: channel 520, channel 522, channel 524, and channel 526. In some implementations, the channels 520, 522, 524, and 526 are contiguous (e.g., each channel 520, 522, 524, and 526 covers consecutive 20 MHz frequency ranges, such as from 1000 MHz to 1080 MHz). In some other implementations, the channels 520, 522, 524, and 526 are not contiguous. While FIG. 5B illustrates four channels, this is merely an example as the techniques disclosed herein may apply for any number of channels.

In some implementations, the AP 504 transmits the first message 510 to STA 506A on channel 526 (e.g., over a first portion of the frequency bandwidth defined by the channels 520, 522, 524, 526). In one aspect, the channel 526 is the primary channel and all STAs operate with a CSMA backoff procedure on the primary channel 526. In a further implementation, the first message 510 includes an identifier (not shown) which identifies the AP 504 as the source of the first message 510, the STA 506A as the destination for the first message 510, or both. In some aspects the first message 510 comprises a signal field (SIG field, not shown) that includes the identifier (not shown). In some aspects, the first message 510 comprises a duration field (not shown) that indicates the duration of the first message 510. STAs that would like to transmit on the remaining channels (e.g., CHs 520, 522, and 524, also known as a second portion of the frequency bandwidth) may use the identifier to determine that they are not the intended recipient of the first message 510 and may then transmit on the unused channels.

In one aspect, after determining it is not the intended recipient of the first message 510 sent by the AP 504, the STA 506B may transmit a second message 512 to the STA 506C. The STA 506B may attempt to transmit the second message 512 over the second portion of the frequency bandwidth (e.g., CHs 520, 522, and 524). Prior to transmission, the STA 506B may perform a CCA procedure on the second portion of the frequency bandwidth (e.g., 60 MHz) to make sure the remaining channels are idle. The STA 506B, after detecting the preamble of the first message 510 sent by the AP 504, may check the CCA on the second portion of the frequency bandwidth for PIFS time. As shown in FIG. 5B, the STA 506B checks the CCA on CH 520, 522, and 524 and determines that CH 524 is busy but CH 520 and 522 are idle. The STA 506B may then transmit the second message 512 to STA 506C over CH 520 and 522 after the PIFS time.

In some aspects, the second message 512 may be limited to the time used by the AP 504 to transmit the first message 510 to the STA 506A. In one aspect, the STA 506B may read the duration field of the first message 510 sent by the AP 504 and limit the transmission time of the second message 512 to the duration indicated in the duration field of the first message 510. In some implementations, the second message 512 may comprise a PPDU. By limiting the second message 512 to the duration of the first message 510 sent by the AP 504, the STA 506B may ensure that all of the STAs 506 may return to regular CSMA procedure on a common channel. In some aspects, the second message 512 may be subject to further limitations which may limit adjacent channel interference. In some aspects, such limitations may include limitations based on the RSSI of the first message 510 sent by the AP 504 or a limitation may require the STA 506B to perform an RTS/CTS procedure. Other limitations for improved performance are also possible.

FIG. 5C shows another timing diagram in which aspects of the present disclosure may be employed. FIG. 5C illustrates the same elements as FIG. 5B, except that in FIG. 5C, channel 520 is an alternate primary channel. In some implementations the AP 504 may designate the alternate primary channel 520. In some implementations, the alternate primary channel 520 may be pre-negotiated. In this implementation, the STA 506B may perform a different CCA procedure than the procedure illustrated in FIG. 5B on the second portion of the frequency bandwidth (e.g., 60 MHz) to make sure the remaining channels 520, 522, 524 are idle. The STA 506B, after detecting the preamble of the first message 510 sent by the AP 504, may perform a backoff procedure on a designated alternate primary channel (e.g., CH 520) within the second portion of the frequency bandwidth. Once a backoff timer expires on the alternate primary channel (e.g., the third portion of the frequency bandwidth), the STA 506B may transmit on the alternate primary channel and on other channels of the remaining portion of the frequency bandwidth, provided the other channels were idle for PIFS time before expiration of the backoff timer. As shown in FIG. 5C, the STA 506B performs the backoff on CH 520, the alternate primary channel. After the backoff, the STA 506B determines that CH 524 is busy but that CH 522 is idle. The STA 506B may then transmit the second message 512 to the STA 506C over the channels 520 and 522 after the backoff time. The same limitations discussed above with reference to FIG. 5B may also apply to the first message 510 and the second message 512 in FIG. 5C.

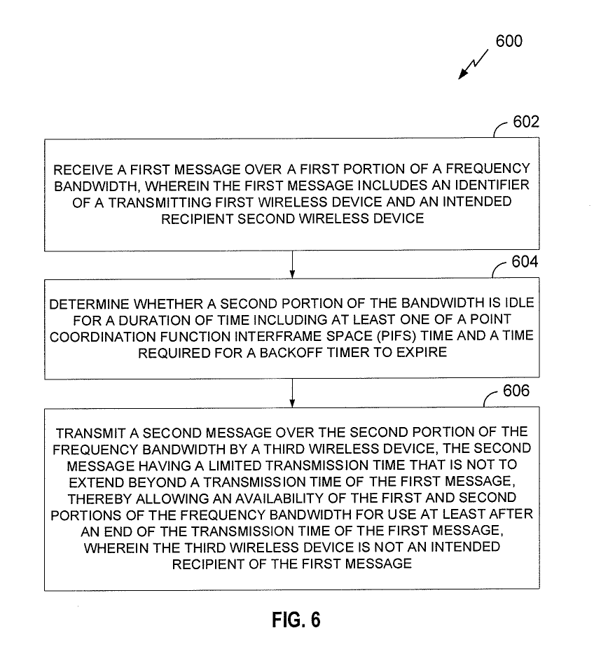

FIG. 6 is a flowchart of a method 600 for wireless communication. In some implementations, the method 600 may be performed by an AP or a STA, such as the AP 504 or the STA 506. The method 600 may begin with block 602, which includes receiving a first message over a first portion of a frequency bandwidth, wherein the first message includes an identifier of a transmitting first wireless device and an intended recipient second wireless device. For example, as previously described in connection with FIGS. 5A-5C, the STA 506B may receive the first message 510, which includes an identifier of a transmitting first wireless device (e.g., the AP 504) and an intended recipient second wireless device (e.g., the STA 506A) of the first message 510.

The method 600 may then advance to block 604, which includes determining whether a second portion of the bandwidth is idle for a duration of time including at least one of a point coordination function interframe space (PIFS) time and a time required for a backoff timer to expire. For example, as previously described in connection with FIG. 5B, after receiving the first message 510, the STA 506B may determine whether a second portion of the frequency bandwidth (e.g., CHs 520, 522 and 524) is idle for a duration of time. With respect to FIG. 5B, this duration of time is described as a PIFS time. With respect to FIG. 5C, this duration of time is described as the amount of time required for a backoff timer to expire, after which transmission may occur on the alternate primary channel 520 as well as any other channel that has been idle for at least PIFS time.

The method 600 may then advance to block 606, which includes transmitting a second message over the second portion of the frequency bandwidth by a third wireless device, the second message having a limited transmission time that is not to extend beyond a transmission time of the first message, thereby allowing an availability of the first and second portions of the frequency bandwidth for use at least after an end of the transmission time of the first message, wherein the third wireless device is not an intended recipient of the first message. For example, as previously described in connection with FIGS. 5A-5C, once the STA 506B determines, based on the identifier in the first message 510, that neither the STA 506B nor the STA 506C is the transmitter nor intended recipient of the first message 510, and after at least one of the other channels 520, 522, 524 are idle for the duration of time (e.g., backoff time and/or PIFS time), the STA 506B may transmit the second message 512 to the STA 506C on the channels 520 and 522, since the channel 524 is busy and the channel 526 is the channel on which the first message 510 is currently being transmitted. This ensures that at least the channels 520, 522 and 526 are available for use at least after an end of the transmission time of the first message 510.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a frequency bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communication, comprising:
receiving a first message over a first portion of a frequency bandwidth, wherein the first message includes an identifier of a transmitting first wireless device and an intended recipient second wireless device,
determining whether a second portion of the bandwidth is idle for a duration of time including at least one of a point coordination function interframe space (PIFS) time and a time required for a backoff timer to expire, and
transmitting a second message over the second portion of the frequency bandwidth by a third wireless device, the second message having a limited transmission time that is not to extend beyond a transmission time of the first message, thereby allowing an availability of the first and second portions of the frequency bandwidth for use at least after an end of the transmission time of the first message, wherein the third wireless device is not an intended recipient of the first message.

2. The method of claim 1, wherein an end of the limited transmission time of the second message occurs earlier than the end of the transmission time of the first message.

3. The method of claim 1, wherein the first message comprises a signal field which includes the identifier of the transmitting first wireless device and the intended recipient second wireless device.

4. The method of claim 1, wherein the backoff timer is decremented while one or more channels within the second portion of the frequency bandwidth is idle.

5. The method of claim 1, wherein the second message is transmitted when a receive signal strength indicator (RSSI) of the first message is below a threshold.

6. The method of claim 5, wherein the threshold is based on an intended transmission power and a reference transmission power.

7. The method of claim 1, further comprising:
transmitting a request to send (RTS) message over the second portion of the frequency bandwidth by the third wireless device when the third wireless device is not the intended recipient of the first message, and
receiving a clear to send (CTS) message in response to the RTS message over the second portion of the frequency bandwidth.

8. The method of claim 1, wherein the third wireless device transmits the second message over a third portion of the frequency bandwidth that is included in the second portion of the frequency bandwidth when the third portion of the frequency bandwidth is idle for at least the PIFS time.

9. An apparatus for wireless communication, comprising:
a receiver configured to receive a first message over a first portion of a frequency bandwidth, wherein the first message includes an identifier of a transmitting first wireless device and an intended recipient second wireless device;
a processor configured to determine whether a second portion of the frequency bandwidth is idle for a duration of time including at least one of a point coordination function interframe space (PIFS) time and a time required for a backoff timer to expire; and
a transmitter configured to transmit a second message over the second portion of the frequency bandwidth, the second message having a limited transmission time that is not to extend beyond a transmission time of the first message, thereby allowing an availability of the first and second portions of the frequency bandwidth for use at least after an end of the transmission time for the first message, wherein the apparatus is not an intended recipient of the first message.

10. The apparatus of claim 9, wherein an end of the limited transmission time of the second message occurs earlier than the end of the transmission time of the first message.

11. The apparatus of claim 9, wherein the first message comprises a signal field which includes the identifier of the transmitting first wireless device and the intended recipient second wireless device.

12. The apparatus of claim 9, wherein the backoff timer is decremented while one or more channels within the second portion of the frequency bandwidth is idle.

13. The apparatus of claim 9, wherein the second message is transmitted when a receive signal strength indicator (RSSI) of the first message is below a threshold.

14. The apparatus of claim 13, wherein the threshold is based on an intended transmission power and a reference transmission power.

15. The apparatus of claim 9, wherein:
the transmitter is further configured to transmit a request to send (RTS) message over the second portion of the frequency bandwidth when the apparatus is not the intended recipient of the first message; and
the receiver is further configured receive a clear to send (CTS) message over the second portion of the frequency bandwidth in response to the RTS message.

16. The apparatus of claim 9, wherein the transmitter is configured to transmit the second message over a third portion of the frequency bandwidth that is included in the second portion of the frequency bandwidth when the third portion of the frequency bandwidth is idle for at least the PIFS time.

17. A non-transitory, computer-readable medium comprising code that, when executed, causes a processor of an apparatus for wireless communication to:
receive a first message over a first portion of a frequency bandwidth, wherein the first message includes an identifier of a transmitting first wireless device and an intended recipient second wireless device,
determine whether a second portion of the frequency bandwidth is idle for a duration of time including at least one of a point coordination function interframe space (PIFS) time and a time required for a backoff timer to expire; and
transmit a second message over the second portion of the frequency bandwidth, the second message having a limited transmission time that is not to extend beyond a transmission time of the first message, wherein the apparatus is not the intended recipient of the first message.

18. The medium of claim 17, wherein an end of the limited transmission time of the second message occurs earlier than the end of the transmission time of the first message.

19. The medium of claim 17, wherein the first message comprises a signal field which includes the identifier of the transmitting first wireless device and the intended recipient second wireless device.

20. The medium of claim 17, wherein the backoff timer is decremented while one or more channels within the second portion of the frequency bandwidth is idle.

21. The medium of claim 17, wherein the second message is transmitted when a receive signal strength indicator (RSSI) of the first message is below a threshold.

22. The medium of claim 20, wherein the threshold is based on an intended transmission power and a reference transmission power.

23. The medium of claim 17, further comprising code that, when executed, causes the apparatus to:
transmit a request to send (RTS) message over the second portion of the frequency bandwidth when the apparatus is not the intended recipient of the first message, and
receiving a clear to send (CTS) message in response to the RTS message over the second portion of the frequency bandwidth.

24. An apparatus for wireless communication, comprising:
means for receiving a first message over a first portion of a frequency bandwidth, wherein the first message includes an identifier of a transmitting first wireless device and an intended recipient second wireless device;
means for determining whether a second portion of the frequency bandwidth is idle for a duration of time including at least one of a point coordination function interframe space (PIFS) time and a time required for a backoff timer to expire; and
means for transmitting a second message over the second portion of the frequency bandwidth, the second message having a limited transmission time that is not to extend beyond a transmission time of the first message, wherein the apparatus is not an intended recipient of the first message.

25. The apparatus of claim 24, wherein an end of the limited transmission time of the second message occurs earlier than the end of the transmission time of the first message.

26. The apparatus of claim 24, wherein the first message comprises a signal field which includes the identifier of the transmitting first wireless device and the intended recipient second wireless device.

27. The apparatus of claim 24, further comprising means for decrementing the backoff timer while one or more channels within the second portion of the frequency bandwidth is idle.

28. The apparatus of claim 24, wherein the means for transmitting the second message is configured to transmit the second message when a receive signal strength indicator (RSSI) of the first message is below a threshold.

29. The apparatus of claim 28, wherein the threshold is based on an intended transmission power and a reference transmission power.

30. The apparatus of claim 24, further comprising:
means for transmitting a request to send (RTS) message over the second portion of the frequency bandwidth when the apparatus is not the intended recipient of the first message; and
means for receiving a clear to send (CTS) message in response to the RTS message over the second portion of the frequency bandwidth.
